(19) United States
(12) Patent Application Publication
(10) Pub. No.: US 2025/0189815 A1
(43) Pub. Date: Jun. 12, 2025

(54) FLEXIBLE BRIDGE ASSEMBLY FOR EYEWEAR AND METHOD OF ASSEMBLING FLEXIBLE EYEWEAR

(71) Applicant: BRENT SHELDON, MIAMI, FL (US)

(72) Inventors: BRENT SHELDON, MIAMI, FL (US); GUY BROUSSEAU, JR., MARIEVILLE (CA)

(21) Appl. No.: 18/950,542

(22) Filed: Nov. 18, 2024

Related U.S. Application Data
(63) Continuation of application No. PCT/CA2023/050689, filed on May 18, 2023.
(60) Provisional application No. 63/343,181, filed on May 18, 2022.

(51) Int. Cl. G02C 5/06; G02C 1/06

(52) U.S. Cl. CPC G02C 5/06; G02C 1/06; G02C 2200/06; G02C 2200/08; G02C 2200/16

(57) ABSTRACT

A flexible bridge assembly for an eyewear is provided. The flexible bridge assembly includes a flexible bridge portion having a first recess at one end, and a second recess at another end. The assembly includes a first rigid attachment member connected at a first end thereof to the first recess of the flexible bridge portion and a second rigid attachment member connected at a first end thereof to the second recess of the flexible bridge portion. The assembly further includes deformable rigid bar extending between the first and second rigid attachment members and embedded within the flexible bridge portion.

### CROSS-REFERENCE TO RELATED APPLICATIONS

This application is a Continuation of PCT Application No. PCT/CA2023/050689 filed on May 18, 2023, which claims priority from U.S. Provisional Patent Application No. 63/343,181 filed on May 18, 2022, the contents of which are incorporated herein by reference in their entirety.

### TECHNICAL FIELD

The following relates to flexible bridges for eyewear, and methods of assembling eyewear to incorporate such flexible bridges.

### BACKGROUND

Eyewear such as eyeglasses generally include a frame that supports one or more lenses. The frame typically includes a nose bridge or nose pieces that engage the user's nose to support the eyewear on the user's head. Eyeglasses also typically include a pair of arms attached to (or integral with) the frame, to further support the eyeglasses, e.g., by resting the arms on the user's ears or engaging their head in the temple region. Other eyewear may include other support elements such as straps or bands (e.g., in sports goggles).

Eyeglasses have traditionally utilized frames or frame components made from substantially rigid materials such as plastics, metals, or composite materials. The rigidity of these materials supports the lenses in the frames, and substantially maintains the shape of the eyeglasses such that they consistently fit on a user's head as intended. A drawback of this rigidity is that the frames can only typically withstand some flexure and can be prone to breakage or deformation.

Flexible components have been used in eyewear, for example, flexible arms and flexible portions of the eyewear frames. Various challenges can arise in construction, assembly, and use when incorporating flexible elements. For example, the flexibility should not cause the frames to deform and thus lose their shape over time. Other challenges include assembly complexities and costs associated with using multiple different materials. Components made of rigid material and components made of flexible material generally can find difficulties adhering to each other, and may require a joining mechanism that should be easy to assemble while also being durable and provide a strong joint.

It is an object of the following to address at least one of the above-noted disadvantages.

### SUMMARY

In one aspect, a flexible bridge assembly for an eyewear is provided. The flexible bridge assembly includes a flexible bridge portion having a first recess at one end, and a second recess at another end. The assembly includes a first rigid attachment member connected at a first end thereof to the first recess of the flexible bridge portion and a second rigid attachment member connected at a first end thereof to the second recess of the flexible bridge portion. The assembly further includes deformable rigid bar extending between the first and second rigid attachment members and embedded within the flexible bridge portion.

In another aspect, a flexible bridge assembly for eyewear is provided. The assembly includes a flexible bridge portion, a first rigid connecting end embedded in the flexible bridge portion at one end and a second rigid connecting end embedded in the flexible bridge at the other end. The flexible bridge assembly further includes a deformable rigid bar extending between the first and second rigid connecting ends and embedded within the flexible bridge portion.

In a yet another aspect, a flexible bridge assembly for an eyewear is provided. The eyewear includes a first lens retainer and a second lens retainer. The assembly includes a first rigid attachment member having at least one prong and at least one slot, and a second rigid attachment member having at least one prong and at least one slot. The flexible bridge assembly further includes a flexible bridge portion comprising a deformable rigid bar extending between the first and second rigid attachment members. The prongs of the first rigid attachment members provide an attachment portion for at least one recess of the first lens retainer; and the prongs of the second rigid attachment members provide an attachment portion for at least one recess of the second lens retainer.

### BRIEF DESCRIPTION OF THE DRAWINGS

Embodiments will now be described with reference to the appended drawings wherein:

FIG. 1 is a perspective view of eyewear with a flexible bridge assembly;

FIG. 2 is an exploded perspective view of the eyewear shown in FIG. 1;

FIG. 3a is an enlarged partial exploded perspective view of the flexible bridge assembly shown in FIG. 1;

FIG. 3b is an enlarged partial exploded perspective view of the flexible bridge assembly shown in FIG. 1, with transparency used to illustrate interior components, including a deformable rigid bar extending between the rigid attachment members;

FIG. 4a is an enlarged partial perspective view of the flexible bridge assembly shown in FIG. 1, with transparency used to illustrate interior components;

FIG. 4b is an enlarged partial perspective view of the flexible bridge assembly shown in FIG. 1;

FIG. 5 is a cross-sectional view of the flexible bridge assembly shown in FIG. 4b along line V-V;

FIG. 6 is an enlarged partial perspective view of a flexible bridge assembly utilizing an alternative fastening mechanism;

FIG. 7 is a perspective view of the mounting members used in the flexible bridge assembly of FIG. 6, shown in isolation;

FIG. 8 is a perspective view of the flexible bridge assembly of FIG. 6, shown in isolation;

FIG. 9 is a cross-sectional view of the flexible bridge assembly shown in FIG. 6 along line IX-IX;

FIG. 10 is an enlarged partial perspective view of a flexible bridge assembly utilizing an alternative connection mechanism;

FIG. 11 is a perspective view of the mounting members used in the flexible bridge assembly of FIG. 10, shown in isolation;

FIG. 12 is a perspective view of the flexible bridge assembly of FIG. 10, shown in isolation;

FIG. 13 is an exploded partial perspective view of the flexible bridge assembly of FIG. 10;

FIG. 14 is an exploded partial front view of the flexible bridge assembly of FIG. 10;

FIG. 15 is an exploded partial front view of the flexible bridge assembly of FIG. 10;

FIG. 16 is an enlarged partial front view of the flexible bridge assembly shown in FIG. 10, with transparency used to illustrate interior components;

FIG. 17a is an exploded partial front view of the flexible bridge assembly utilizing an alternative prong design;

FIG. 17b is an exploded partial perspective view of the lens retainer utilizing an alternative recess design;

FIG. 18 is an exploded partial front view of the flexible bridge assembly utilizing another alternative prong design;

FIG. 19 is an exploded partial front view of the flexible bridge assembly utilizing yet another alternative prong design;

FIG. 20 is an exploded partial front view of the flexible bridge assembly utilizing yet another alternative prong design.

### DETAILED DESCRIPTION

According to the embodiments of this disclosure, to provide flexibility in eyewear such as eyeglasses, sunglasses, safety eyewear and the like; a flexible bridge assembly can be utilized. The flexible bridge assembly includes rigid attachment members that are at least partially contained or embedded in a flexible body to provide attachment points to lens retainers in the eyewear, with the flexible body therebetween, allowing flexibility of the eyewear at or about the bridge assembly. In an embodiment, the flexible bridge assembly can also embed a deformable rigid bar extending between the rigid attachment members. Including such a deformable rigid bar adds to or otherwise customizes the resistance to flexure of the flexible bridge assembly. Similarly, the deformable rigid bar, via its inherent elastic deformability and resilience, further encourages a return to rest for the overall assembly after being flexed. The deformable rigid bar can also connect to the rigid attachment members to connect otherwise separate parts and facilitate aligning and holding them in place during assembly (e.g., during an overmolding process) to further assist in the accuracy and efficiency of such a process. Moreover, shape memory and other alloys can be used to enable a user to customize or otherwise adjust the rest position of the flexible portion, e.g., by including a slight bend to accommodate the specific user.

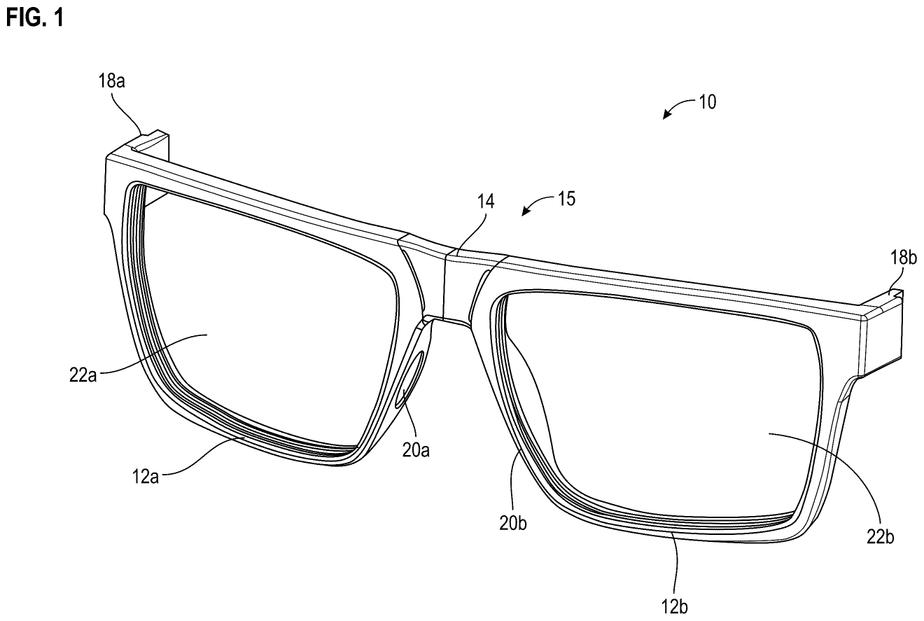

Turning now to the figures, FIG. 1 provides a perspective view of an example assembled eyewear 10, also referred to interchangeably herein as an eyewear assembly 10 or eyewear 10 for brevity. The eyewear 10 includes a pair of separate lens retainers 12, in this example, a first lens retainer 12a and a second lens retainer 12b. The lens retainers 12a, 12b may be adapted to hold lenses, for example, a first lens 22a is held by first lens retainer 12a and a second lens 22b is held by second lens retainer 12b. A first arm 18a is connected to the first lens retainer 12a, and a second arm 18b is connected to the second lens retainer 12b. The first lens retainer 12a includes or otherwise supports a first nose piece 20a, and the second lens retainer 12b includes or otherwise supports a second nose piece 20b. The nose pieces 20 may also be referred to as, or considered to be, nose engaging portions or nose pads. Moreover, the nose pieces 20 shown in FIG. 1 are for illustrative purposes only.

The lens retainers 12a and 12b are connected to each other, for example, via a flexible bridge assembly 15, which as shown in greater detail below, includes a flexible bridge portion 14, also referred to interchangeably herein as the bridge portion 14. The lens retainers 12a and 12a are connected to the flexible bridge assembly 15 such that they are positioned on either side of the user's head and aligned with their eyes. The flexible bridge assembly 15 enables the eyewear 10 to be flexed such that the lens retainers 12a, 12b and arms 18a, 18b attached thereto can be bent or otherwise separated or twisted relative to each other. This allows, for example, a user to slightly flex the arms 18a, 18b away from each other when placing the eyewear 10 on their head, with resiliency in the flexible bridge portion 14 causing the arms 18a, 18b to return towards each other and seat against the user's head and on their ears. The flexibility also resists breakage of the lens retainers 12a, 12b by permitting them to flex, twist, and to a certain extent, fold, e.g., if the eyewear 10 falls, is sat upon by the user, is stuffed into a purse or bag, etc.

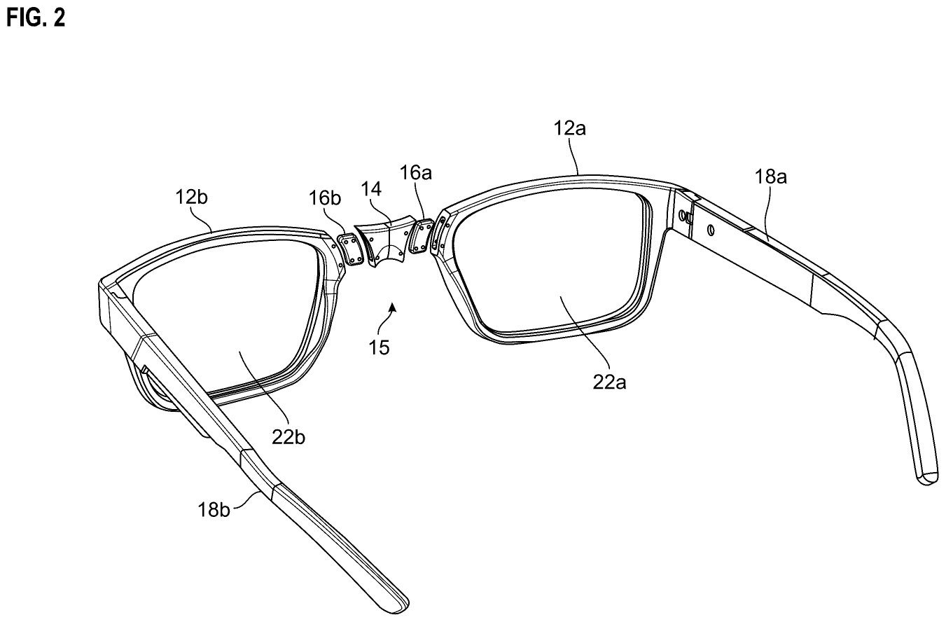

The components of the flexible bridge assembly 15 and the manner in which the assembly 15 connects to the lens retainers 12a, 12b is illustrated in FIG. 2. The flexible bridge portion 14 may be constructed from a flexible material, including one or more of an elastomer such as thermoplastic polyurethane (TPU), rubber or thermoplastic rubber (TRP), soft plastic, or any other suitable material known in the art. The lens retainers 12a, 12b may be made from rigid materials, such as plastic, wood, acetate, composite materials, or another suitable rigid material. In an embodiment, the flexible bridge assembly 15 and the lens retainers 12a, 12b are joined to each other using rigid attachment members 16, also referred to interchangeably herein as mounting members 16. The mounting members 16 in this example are relatively thinner than the flexible bridge portion 14 and lens retainers 12, to allow them to be at least partially embedded or contained within the respective slots formed in the flexible bridge portion 14 and the respective lens retainers 12. In this example the first lens retainer 12a is attached to the flexible bridge assembly 15 by a first rigid attachment member 16a, and the second lens retainer 12b is attached to the other side of the flexible bridge assembly 15 by a second rigid attachment member 16b. This effectively couples the first lens retainer 12a to the second lens retainer 12b via the flexible bridge portion 14 to provide the aforementioned flexibility and resiliency. In some implementations, the mounting members 16 may be made of metal, carbon fiber, plastic, or any other suitable rigid material.

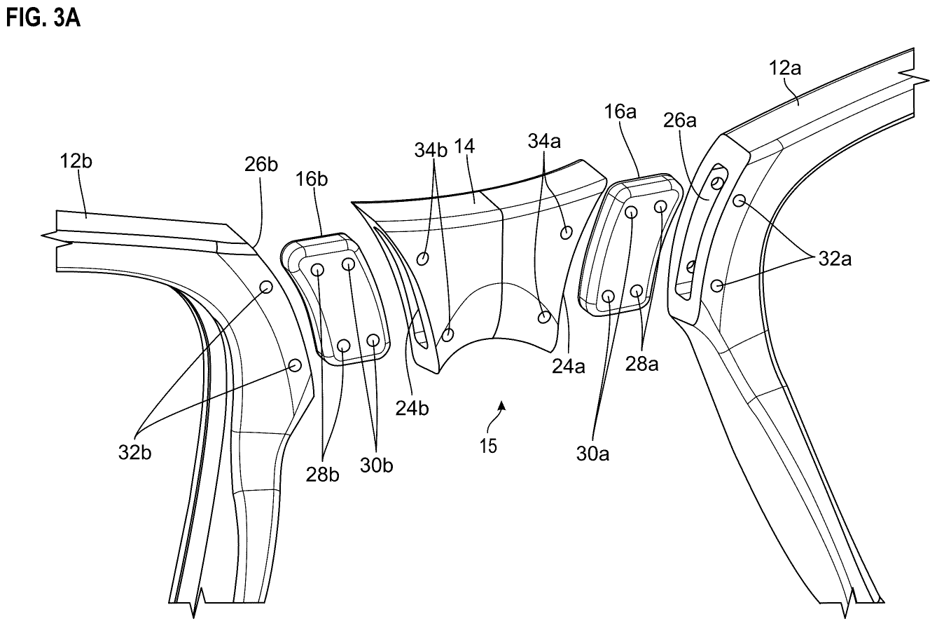

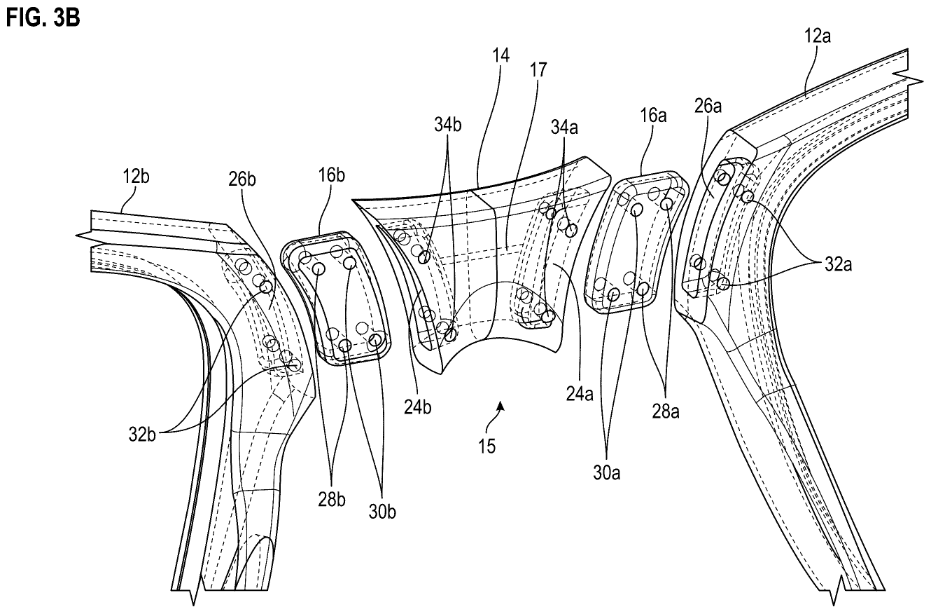

Additional details of the components and manner of assembling the flexible bridge assembly 15 to and with the lens retainers 12a, 12b are shown in the enlarged exploded partial perspective views illustrated in FIGS. 3a and 3b. As shown in FIGS. 3a and 3b, the lens retainers 12a, 12b are constructed with slots, notches or recesses 26. In one implementation, the recesses 26 are shaped and contoured to be complementary to the outwardly extending ends of the corresponding attachment members 16, such that the recesses 26 can accept a portion of the respective mounting members 16a, 16b for attachment thereto. In this example, the first lens retainer 12a has a first lens retainer recess 26a, and second lens retainer 12b has a second lens retainer recess 26b. Further, in an embodiment, the flexible bridge portion 14 is constructed to include a bridge recess 24 at each end, such that one bridge recess 24 faces each lens retainers 12a, 12b to accept the other end of the respective attachment members 16. For example, the bridge recesses 24 are also sized and contoured to be complementary to and accept the other ends of mounting members 16a, 16b. One end of first mounting member 16a may be inserted into a first bridge recess 24a, and one end of second mounting member 16b may be inserted into a second bridge recess 24b. In an embodiment, as seen in FIG. 3b, the flexible bridge assembly includes a deformable but rigid bar 17, hereinafter referred to as the deformable rigid bar 17, which is embedded within the flexible bridge portion 14 and extends between the first and second bridge recesses 24a, 24b and thus the first and second mounting members 16a, 16b, as discussed in greater detail later.

In this example, the lens retainers 12 are each provided with one or more lens retainer passages 32 that pass from the rear face of the lens retainers 12a, 12b, through the respective lens retainer recesses 26 and partially through the front face of the lens retainer 12 (i.e. countersunk into the front face). Specifically, in this example, the first lens retainer 12a has a pair of first lens retainer passages 32a and the second lens retainer 12b has a pair of second lens retainer passages 32b. It can be appreciated that any suitable number of passages 32 can be provided. The lens retainer passages 32a, 32b extend to both sides of the lens retainer recesses 26a, 26b to align with the corresponding passages in the attachment members 16 as described below. Similarly, the flexible bridge portion 14 is provided with a set of one or more bridge passages 34 on both sides thereof, which pass through the respective bridge recesses 24 in a similar manner, in order to align with further passages in the attachment members 16 as described below.

In an embodiment, the mounting members 16a, 16b are each provided with a first set of one or more passages 28 on the lens retainer side, and a second set of one or more passages 30 on the flexible bride portion side. It is preferred that there be the same number of lens retainer passages 32 as first set of passages 28, and likewise the same number of bridge passages 34 as second set of passages 30. In this example, the first mounting member 16a has a pair of first passages 28a and a pair of second passages 30a. Similarly, the second mounting member 16b has a pair of its own first passages 28b and a pair of its own second passages 30b. As can be appreciated from the views shown in FIGS. 3a and 3b, the sets of passages described above are provided to be in alignment to allow the attachment members 16 to be secured to both the flexible bridge portion 14 and the lens retainers 12 as described in greater detail below.

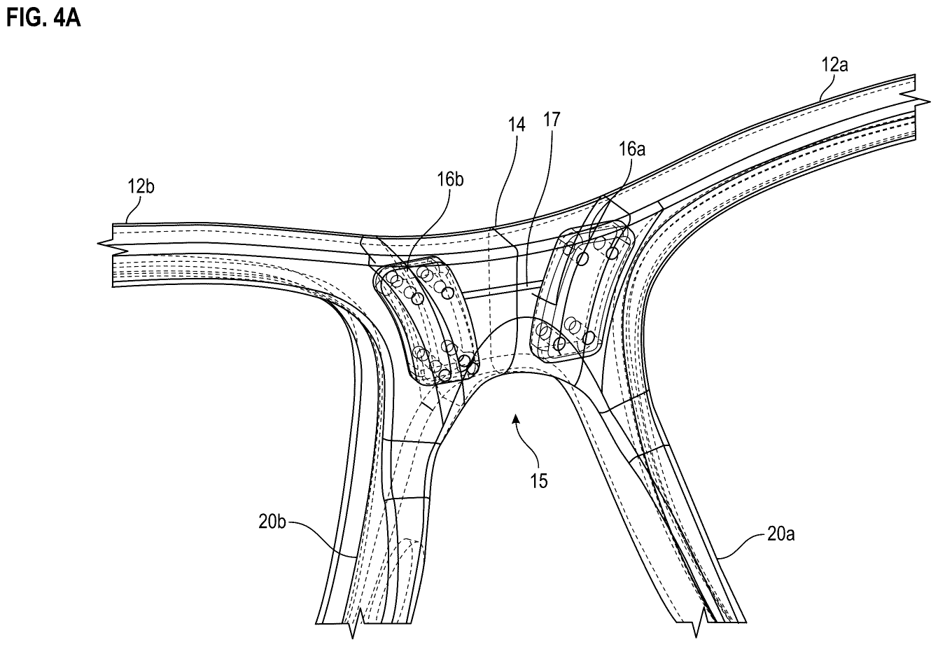

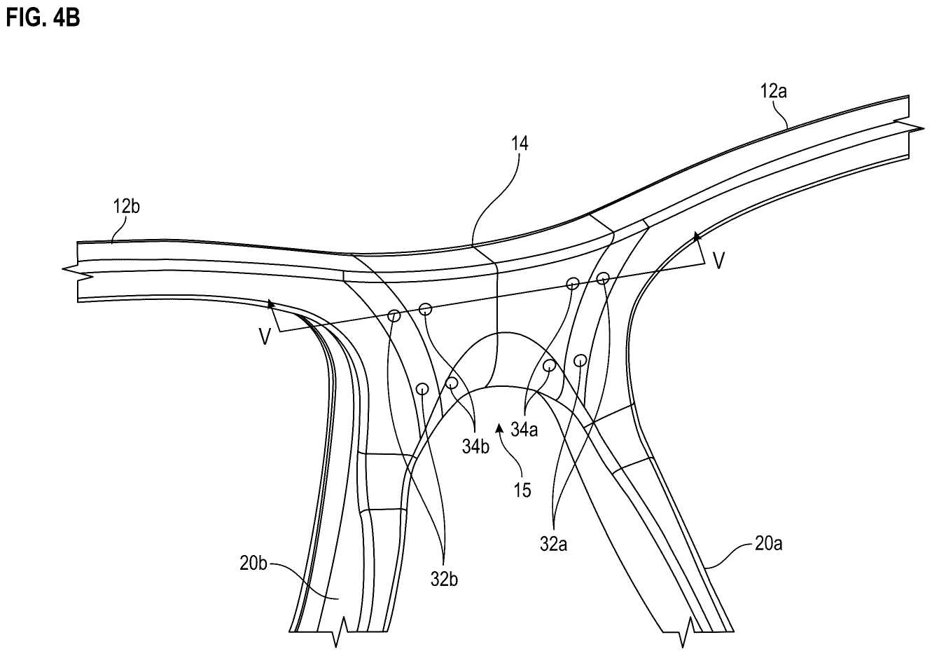

Turning now to FIGS. 4A and 4B, it can be observed that the eyewear 10 can be assembled by inserting the mounting members 16a, 16b into both the lens retainer recesses 26a, 26b at one end, and into the bridge recesses 24a, 24b at the other end. In this example, mounting members 16a, 16b are sized and contoured such that when they are inserted into lens retainer recesses 26a, 26b and bridge recesses 24a, 24b, the peripheral faces of bridge portion 14 bear against the lens retainers 12a, 12b to create a contiguous fit between the flexible bridge portion 14 and the lens retainers 12a, 12b. However, it can be appreciated that the mounting members 16a, 16b may also be wider such that the peripheral faces of bridge 14 do not directly contact the lens retainers 12a, 12b and, as such, the contiguous fit is not necessarily required.

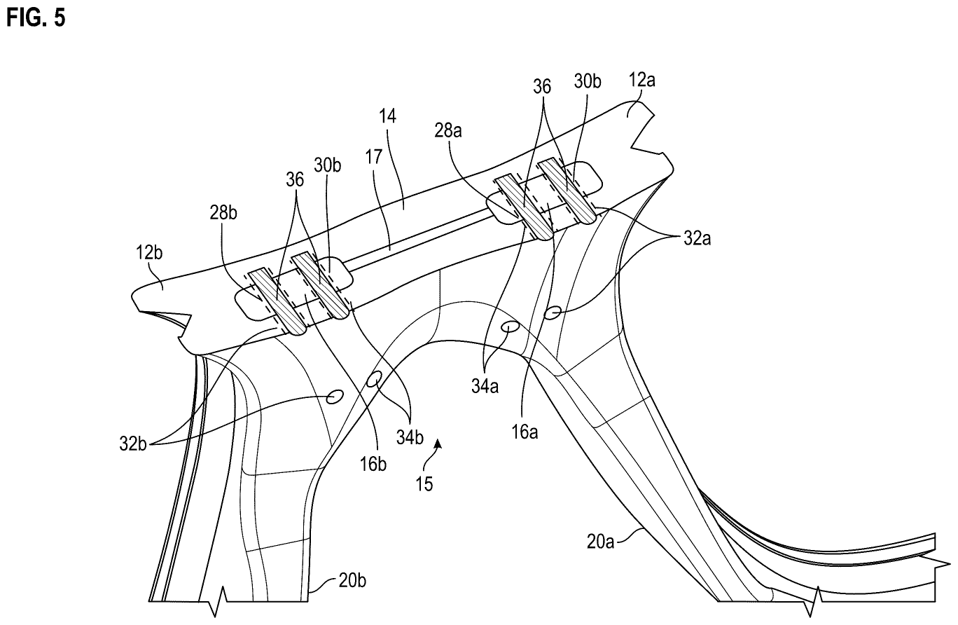

It can be observed additionally from FIG. 5 that when the first mounting member 16a is inserted into the first lens retainer 12a and into the flexible bridge portion 14 as described above, the first lens retainer passages 32a are aligned with the first set of passages 28a, and the first bridge passages 34a are aligned with the second set of passages 30a. Similarly, when the second mounting member 16b is inserted into the second lens retainer 12b and into the flexible bridge portion 14 as described above, the second lens retainer passages 32b are aligned with the first set of passages 28b on the second mounting member 16b, and the second bridge passages 34b are aligned with the second set of passages 30b on the second mounting member 16b. These alignments enable the components to be attached to each other.

Further, FIG. 5 also illustrates the deformable rigid bar 17 in a cross-sectional view. In an embodiment, the deformable rigid bar 17 is configured to extend through the flexible bridge portion 14 between the bridge recesses 24a, 24b (and when assembled as shown, between the first and second mounting members 16a, 16b). In some implementations, the deformable rigid bar 17 can be inserted or otherwise included or embedded within the material that forms the flexible bridge portion 14. For example, the deformable rigid bar 17 can be made from, for example, an elastically deformable metal that is capable of being bent while returning to its original shape. Due to its inherent rigidity, the deformable rigid bar 17 provides strength to the bridge portion 14 when being embedded within the otherwise flexible bridge portion 14 which is formed from a flexible material (e.g., overmolded in one example). This can add to the rigidity of the bridge assembly 15 when the mounting members 16a, 16b are inserted or otherwise partially embedded in the flexible bridge portion 14. In some implementations, the deformable rigid bar 17 can be chosen to have a thickness and material to fine tune the flexibility of the bridge portion 14 while reforming to its original shape after being flexed as illustrated herein. For example, a rigidity factor of the eyewear may be determined and a suitable thickness and material for the deforming rigid bar 15 may be identified to satisfy the determined rigidity factor.

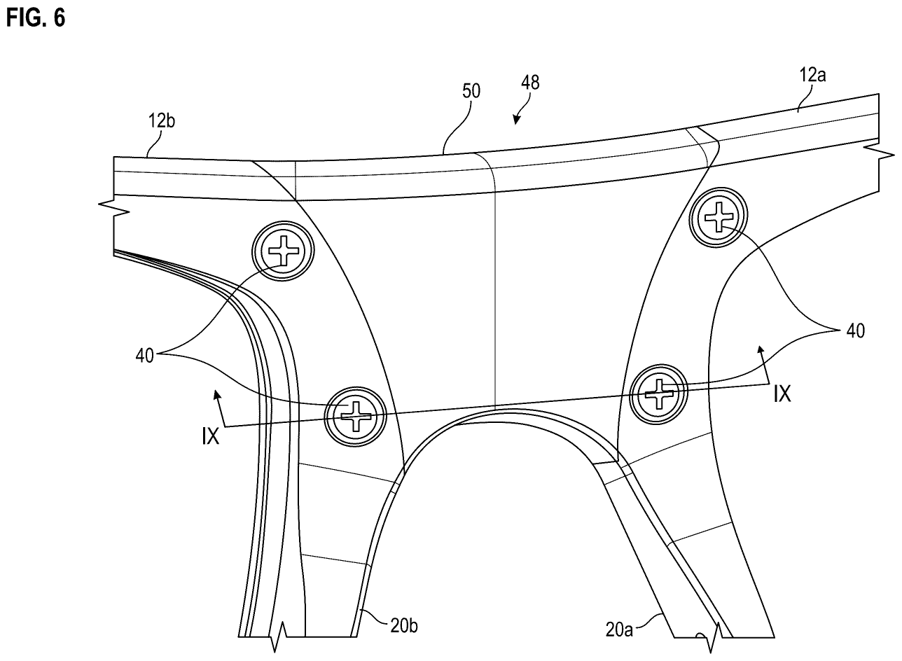

Further, fastening material, or more generally fasteners 36 may be inserted through the aligned passages 28a and 32a, 28b and 32b, 30a and 34a, and 30b and 34b to join the flexible bridge portion 14, having the deformable rigid bar 17 embedded therein, to the lens retainers 12a, 12b via the mounting members 16a, 16b. In one implementation, the fasteners 36 are provided by injecting a fastening material such as a resin, which may be poured or otherwise introduced into the aligned passages 28a and 32a, 28b and 32b, 30a and 34a, and 30b and 34b after assembly of the bridge 14, lens retainers 12a, 12b, and mounting members 16a, 16b, then hardened or set. The fasteners 36 may then be buffed or polished such that they are flush with the bridge portion 14 and surfaces of the lens retainers 12 for aesthetic purposes. In an alternate embodiment, fasteners 36 may be screws (e.g., as seen in FIG. 6), dowels, adhesive, rivets or any suitable fastening device.

FIGS. 6 through 9 illustrate another implementation of the flexible bridge assembly denoted by numeral 48. In this implementation, a flexible bridge portion 50 is created by overmolding a flexible material onto connecting ends and over/around the deformable rigid bar 17, as described in greater detail below. This forms a bridge assembly 48 which can be attached to lens retainers 12a, 12b by fasteners 40, such as the screws shown in FIG. 6.

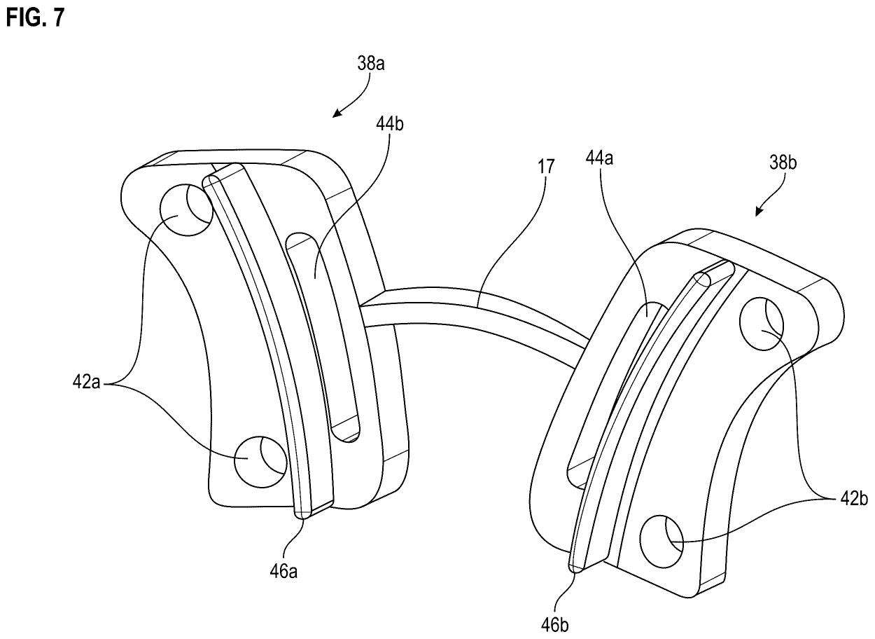

The connecting ends 38 used to join the overmolded flexible bridge portion 50 to the lens retainers 12a, 12b are shown in FIG. 7. In this example, a first connecting end 38a joins the first lens retainer 12a to the overmolded bridge portion 50, and a second connecting end 38b joins the second lens retainer 12b to the overmolded bridge portion 50. In some implementations, the connecting ends 38a, 38b may be made from a rigid material to provide stability and support for the eyewear 10 when the overmolded bridge 48 is attached to the lens retainers 12a, 12b. For example, the connecting ends 38a, 38b may be made from metal by machining or stamping, or from polymers such as polycarbonate. It should be apparent that any other rigid material may also be used to form the connecting ends 38a, 38b using methods commonly used in the art.

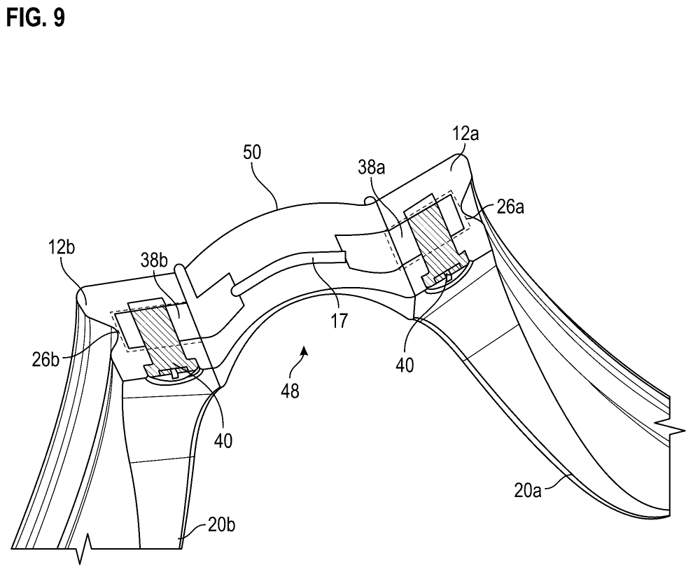

FIG. 7 also illustrates the deformable rigid bar 17 that extends, for example, between the first and second connecting ends 38a, 38b. It can be appreciated that the deformable rigid bar 17 is shown as a separate and distinct piece in FIG. 7 for illustrative purposes only and that the deformable rigid bar 17 can also be integrally constructed with the first and second connecting ends 38a, 38b, to provide a single piece that is overmolded to form the overmolded bridge assembly 48. In some implementations, the deformable rigid bar 17 may be made from a separate material from that of the connecting ends 38a, 38b to provide the elastic deformability discussed above. In some examples, the deformable rigid bar 17 can be attached to the connecting ends 38a, 38b as illustrated in FIG. 7, while in some other examples, may define or have a small separation or gap with the connecting ends 38a, 38b (e.g., if embedded in the overmolded bridge 48 in any embodiment described herein). Further, by being embedded within the flexible material of the flexible overmolded bridge assembly 48, any flexure thereof will likewise flex the deformable rigid bar 17 with any additional rigidity or resistance to the flexure imparted on the overmolded bridge assembly 48. When attached, the deformable rigid bar 17 can be, for example, fastened, welded, fused, or otherwise coupled thereto. FIG. 9 illustrates the flexure of the deformable rigid bar 17 as the overmolded bridge assembly 48 is flexed. As noted above, when released, the deformable rigid bar 17 returns to its original shape shown in FIG. 5 or 7.

Further, one side of the connecting ends 38 may be provided with one or more slots 44 (or other passages) for receiving material during the overmolding process, as described in detail below. In this example, the first connecting end 38a is provided with an elongated slot 44a, and the second connecting end 38b is provided with an elongated slot 44b. The connecting ends 38 may also be provided with attachment passages 42, which may be threaded for receiving a screw. For example, the first connecting end 38a is provided with two first attachment passages 42a, and the second connecting end 38b is provided with two second attachment passages 42b. In some implementations, the slots 44a, 44b and attachment passages 42a, 42b may be separated by ridges 46. In this example, first connecting end 38a is provided with first ridge 46a on one face, and second connecting end 38b is provided with second ridge 46b on one face. The ridges 46a, 46b can be provided for stability when brought against the lens retainers 12a, 12b as shown in FIG. 9.

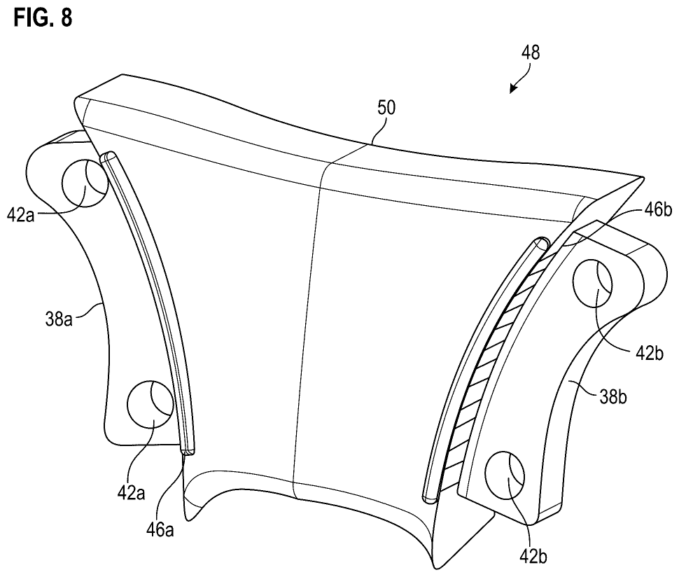

In an embodiment, the material that forms the overmolded bridge portion 50 can be overmolded on the connecting ends 38a, 38b and deformable rigid bar 17 to create the flexible bridge assembly 48 that can then be joined to the lens retainers 12a, 12b in constructing the eyewear 10, as illustrated in FIG. 8. The construction of the flexible bridge assembly 48 can be done using, for example, any suitable overmolding process. Overmolding, sometimes referred to as two times injection molding, is a process where a single part is created using two or more different materials in combination. Typically, a first material (or a substrate) is partially or fully covered by overmolded material during the manufacturing process. In this case, a portion of the connecting ends 38a, 38b and the deformable rigid bar 17 may act as the substrate that is overmolded with the material used to create the overmolded bridge portion 50.

In some implementations, the overmolded material generally includes one or more of an elastomer such as thermoplastic polyurethane (TPU), rubber or thermoplastic rubber (TRP), soft plastic, or any other suitable material. The material may be molded such that peripheral faces of the overmolded bridge 50 at least partially bear against the raised ridges 46a, 46b. It can be appreciated that the flexible material would typically be overmolded to the connecting ends 38a, 38b and the deforming rigid bar 17 prior to attaching the bridge assembly 48 to the lens retainers 12a, 12b. That is, the bridge assembly 48 may, in some examples, be constructed as a separate component that is incorporated into the assembly process.

As shown in FIG. 7, the connecting ends 38a, 38b, in some implementations, are provided with the one or more slots 44a, 44b for the overmolding process. For example, the material of the overmolded bridge 50 may flow through the slots 44a, 44b and around the deformable rigid bar 17 during the overmolding process and fill those slots 44a, 44b to provide additional gripping and encapsulation of connecting ends 38a, 38b, forming a stronger hold between the overmolded bridge portion 50 and the connecting ends 38a, 38b. It can be appreciated that the elongated slots 44a, 44b are shown in FIG. 7 for illustrative purposes only and any one or more slots or holes of any geometry can be used.

FIGS. 6 and 9 show that the eyewear 10 may be assembled, for example, by inserting the connecting ends 38a, 38b of bridge assembly 48 into the lens retainer recesses 26a, 26b of lens retainers 12a, 12b, and aligning lens retainer passages 32a, 32b with attachment passages 42a, 42b similar to the first implementation described above. As explained above, the deformable rigid bar 17 may facilitate proper alignment of the passages as well as the lens retainers with the flexible bridge assembly. Fasteners 40 may be inserted into attachment passages 42a, 42b through lens retainer passages 32a, 32b to secure connecting ends 38a, 38b in place, thereby joining overmolded flexible bridge portion 50 to the lens retainers 12a, 12b. In this example, the fasteners 40 are screws and attachment passages 42 are threaded to hold fasteners 40. However, it can be appreciated that other fasteners and fastening techniques and mechanisms can be utilized.

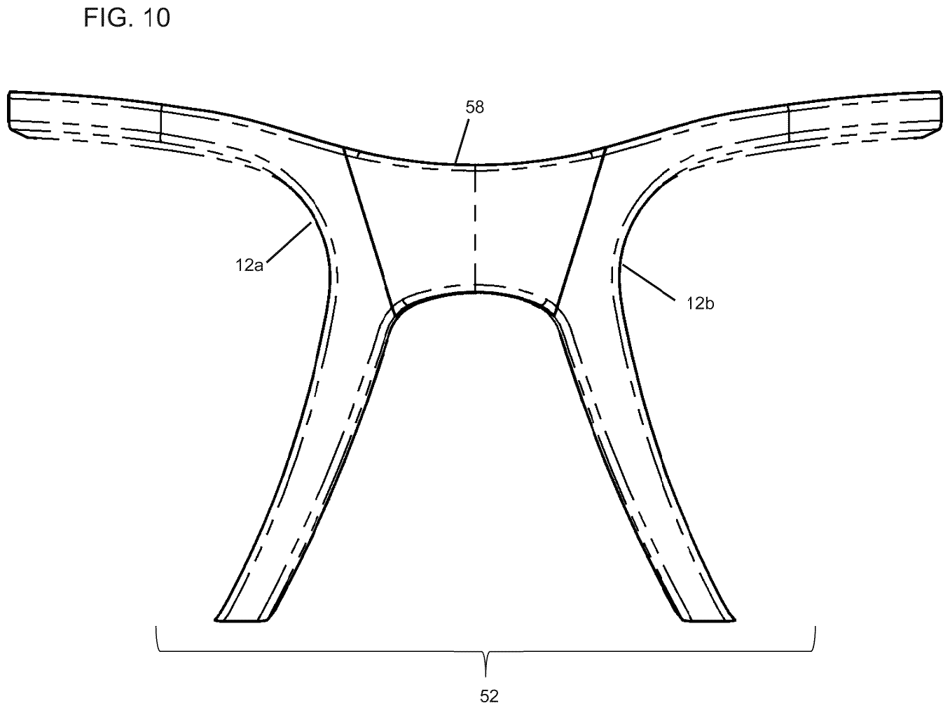

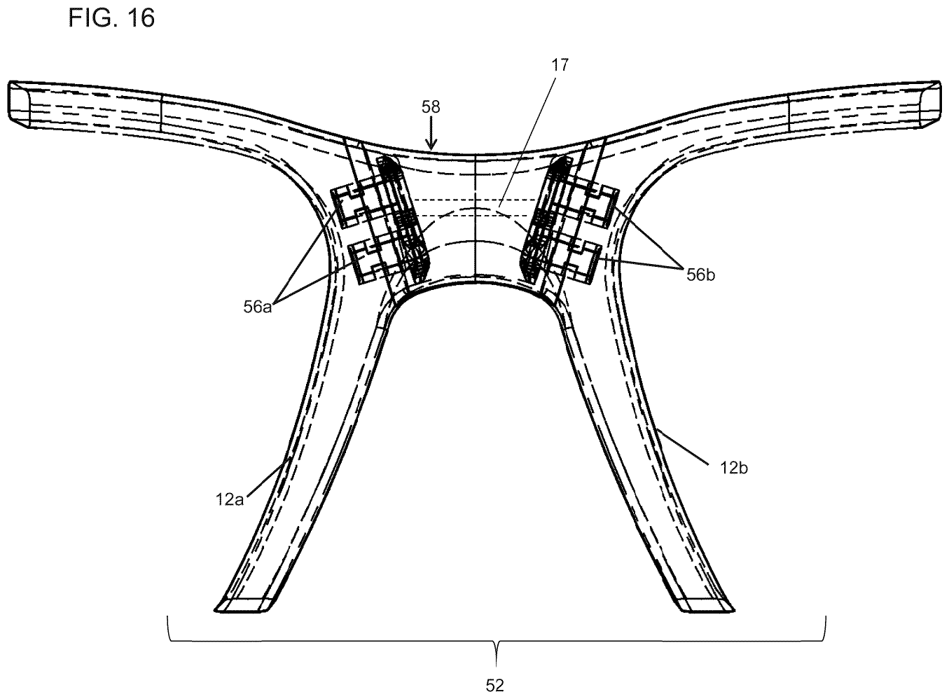

FIGS. 10 through 16 illustrate another implementation of the flexible bridge assembly denoted by numeral 52. In this implementation, a flexible bridge portion 58 is created by overmolding a flexible material onto connecting ends 54 and a deformable rigid bar 17, as described in greater detail below. This forms a bridge assembly 52 which can be attached to lens retainers 12a, 12b.

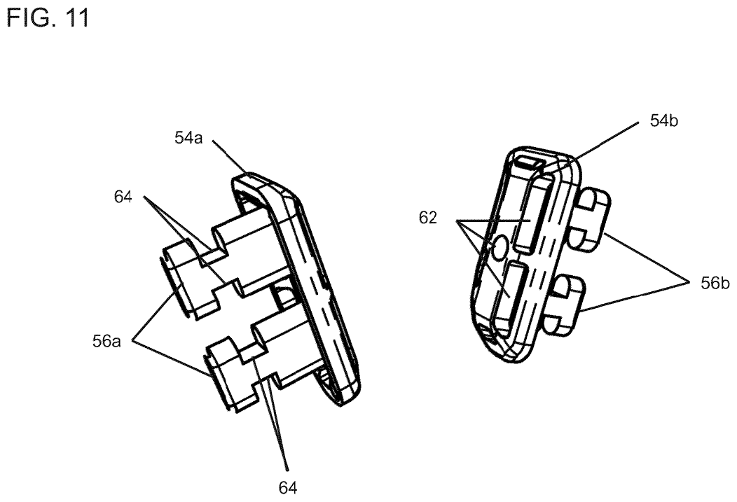

The connecting ends 54 can be used to join the overmolded flexible bridge portion 50 to the lens retainers 12a, 12b. In this example, at least one prong 56a protrudes from first connecting end 54a and joins the first lens retainer 12a to the overmolded bridge portion 58, and at least one prong 56b protrudes from second connecting end 54b and joins the second lens retainer 12b to the overmolded bridge portion 58. This embodiment is shown in FIG. 11. The connecting ends 54a, 54b are made from a rigid material to provide stability and support for the eyewear 10 when the overmolded bridge 58 is attached to the lens retainers 12a, 12b. For example, the connecting ends 54a, 54b may be made from metal by machining or stamping, or from polymers such as polycarbonate. It should be apparent that any other rigid material may also be used to form the connecting ends 54a, 54b using methods commonly used in the art.

In some implementations, one side of the connecting ends 54 may be provided with one or more passages 62 (shown in FIG. 11) for receiving material during the overmolding process, as described in detail below.

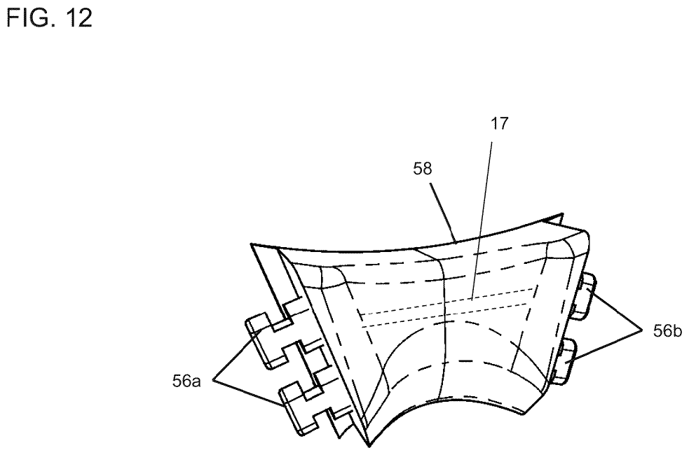

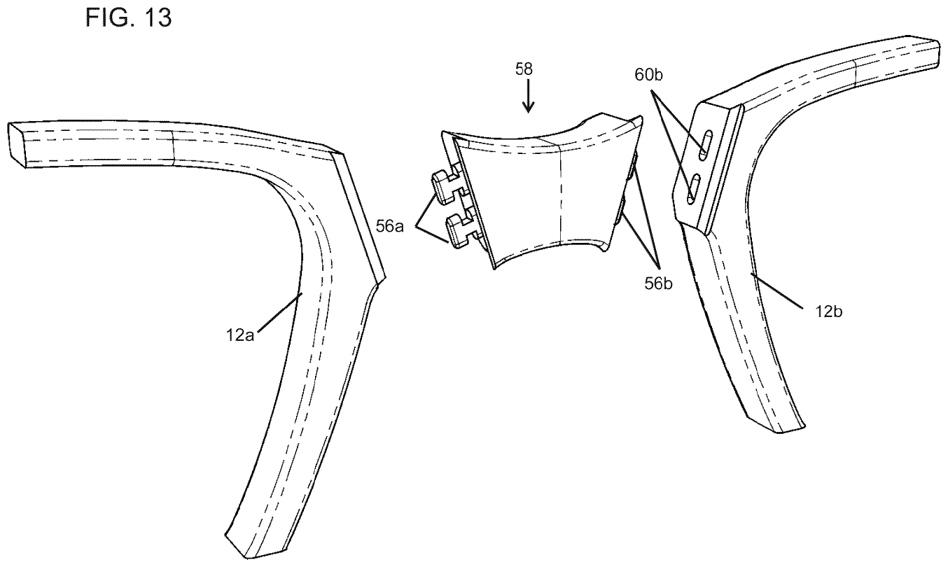

The material that forms the overmolded bridge portion 58 can be overmolded on the connecting ends 54a, 54b to create the flexible bridge assembly 48 that can then be joined to the lens retainers 12a, 12b in constructing the eyewear 10, as illustrated in FIGS. 12 and 13. In some implementations, the construction of the flexible bridge assembly 52 can be done using any suitable overmolding process. In this case, a portion of the connecting ends 54a, 54b act as the substrate that is overmolded with the material used to create the overmolded bridge assembly 58. The prongs 56 may also act as the substrate that is overmolded. FIG. 12 also illustrates the deformable rigid bar 17, which can be embedded in the overmolded bridge portion 58 and/or can be connected to the connecting ends 54a, 54b, in accordance with some implementations.

The overmolded material is generally an elastomer such as thermoplastic polyurethane (TPU), rubber or thermoplastic rubber (TRP), soft plastic, or any other suitable material. It can be appreciated that the flexible material would typically be overmolded to the connecting ends 54a, 54b and deformable rigid bar 17 prior to attaching the bridge assembly 52 to the lens retainers 12a, 12b. That is, in some examples, the bridge assembly 52 is constructed as a separate component that is incorporated into the assembly process.

Further, as shown in FIGS. 11 and 12 the connecting ends 54a, 54b, in some examples, can be provided with the one or more passages 62 for the overmolding process. The material of the overmolded bridge 58 may flow through the passages 62 during the overmolding process and fill those passages 62 and flow over and around the deformable rigid bar 17, to provide additional gripping and encapsulation of connecting ends 54a, 54b, thereby forming a stronger hold between the overmolded bridge portion 58 and the connecting ends 54a, 54b. It can be appreciated that the elongated passages 62 are shown in FIG. 11 for illustrative purposes only and any one or more slots or holes of any geometry can be used. FIG. 12 illustrates an embodiment of the connecting ends 54a, 54b, which are overmolded to form the overmolded bridge assembly 58.

In some examples, the prongs 56 may include notches 64 for securing the flexible bridge portion 50 to the lens retainers 12. One side of the lens retainer 12a may be provided with slots 60a for receiving the prongs 56a and one side of the lens retainer 12b may be provided with slots 60b for receiving the prongs 56b; as illustrated in FIG. 13.

Fasteners such as screws may also be used to join the flexible bridge assembly 50 to the lens retainers 12. The flexible bridge assembly 50 and lens retainers 12 may include passages which align such that the fasteners are inserted, the aligned passages join the flexible bridge assembly 50 to the first and second lens retainers 12a, 12b.

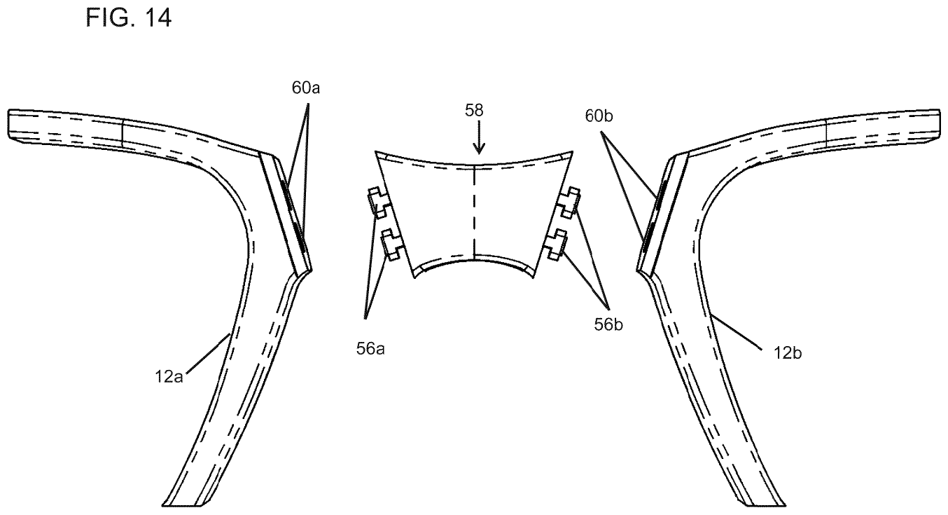

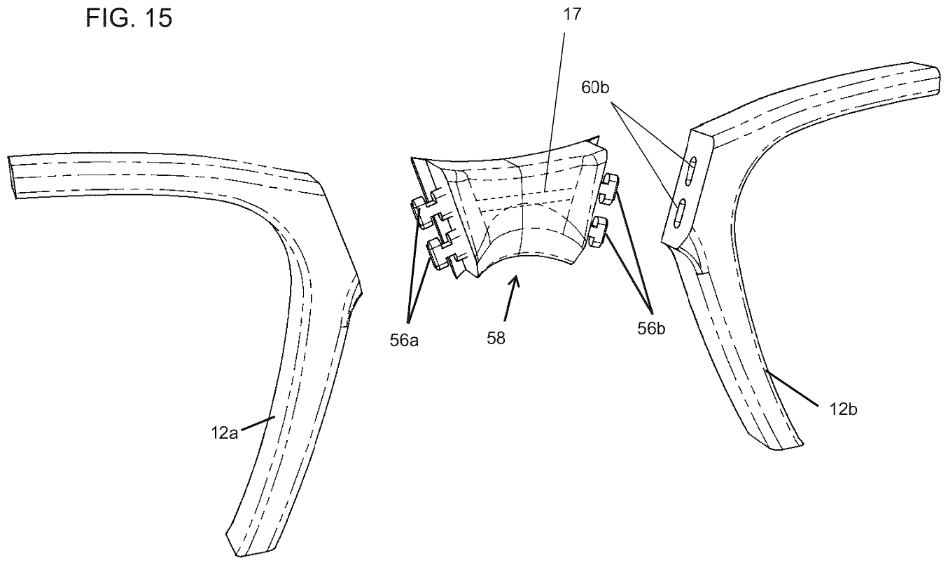

FIGS. 14, 15 and 16 show that the eyewear 10, in some implementations, may be assembled by inserting or snapping the prongs 56a, 56b of bridge assembly 48 into the lens retainer recesses 60 of lens retainers 12a, 12b. Snapping the prongs 56 into the lens retainer recesses 60 can cause the prongs to deform slightly to be seated within the lens retainer recesses 60. The overmolded bridge 58 can be snapped into the lens retainer recesses 60 permanently or detachably, depending on the shape of the prongs 56 and lens retainer recess 60. FIG. 15 also illustrates the deformable rigid bar 17, which can be embedded in the overmolded bridge portion 58 and/or can be connected to the connecting ends 54a, 54b, as described above.

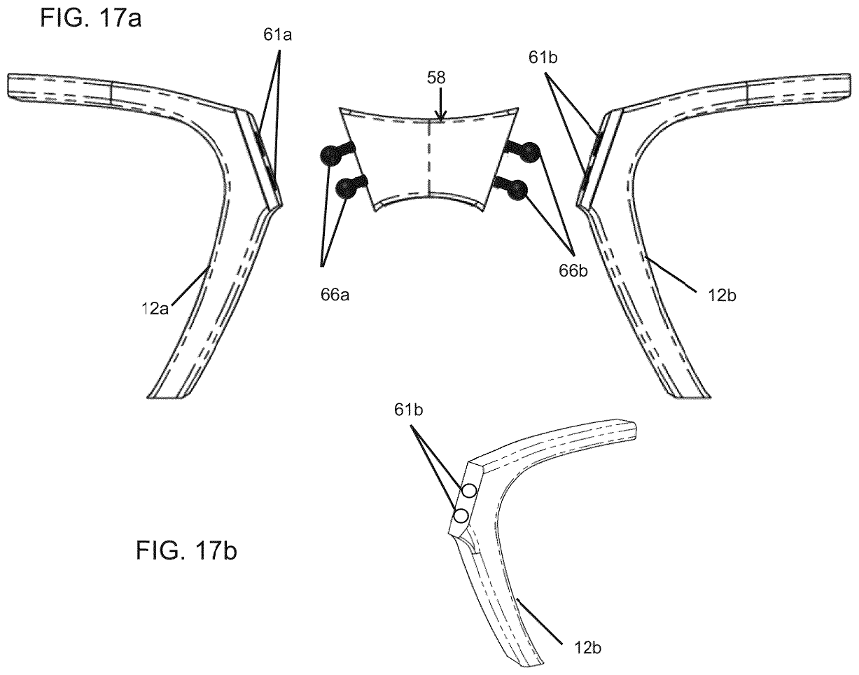

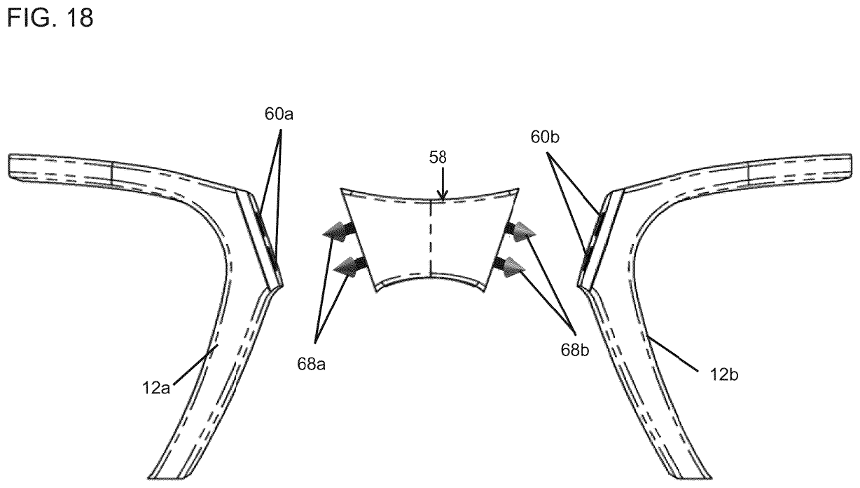

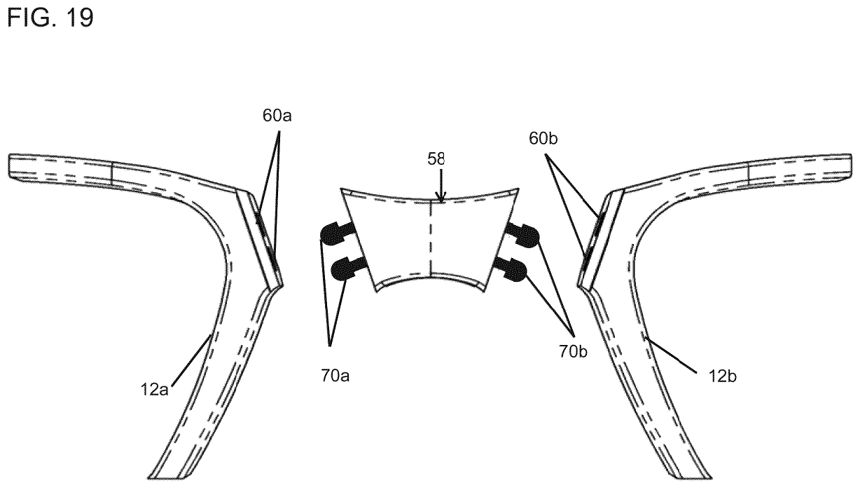

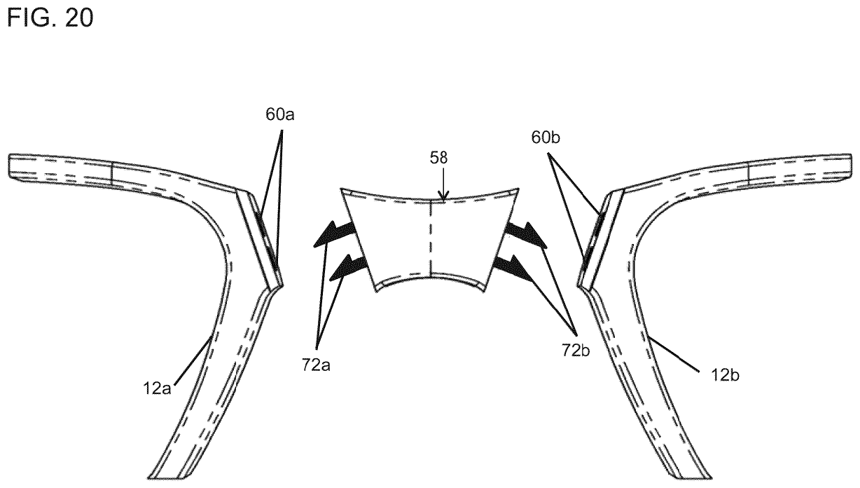

FIGS. 17, 18, 19 and 20 show alternative prong designs which can be used including spherical prongs 66, conical prongs 68, ‘D’ prongs 70, and saw-tooth prongs 72. The lens retainer recesses 61, 60 can be shaped to match the shape of the respective prongs. For example, in FIG. 17a, the prongs 66 are spherical in shape and thus, in the partial perspective view (FIG. 17b) of the lens retainer 12b, it can be seen that the lens retainer recesses 61 are shaped in a circular manner; such that the prongs 66 can be snapped into the lens retainer recesses 61. The shape of the lens retainer recesses 60 is dictated by the shape of the prong 66, 68, 70 or 72 that is to be inserted. Some prong shapes such as spherical prongs 66 are detachably snapped into the lens retainer recesses 61, such that they can be disjoined in needed. Other prong shapes such as the saw-tooth prongs 72 can permanently attach the overmolded bridge 58 to the lens retainer 12.

For simplicity and clarity of illustration, where considered appropriate, reference numerals may be repeated among the figures to indicate corresponding or analogous elements. In addition, numerous specific details are set forth in order to provide a thorough understanding of the examples described herein. However, it will be understood by those of ordinary skill in the art that the examples described herein may be practiced without these specific details. In other instances, well-known methods, procedures, and components have not been described in detail so as not to obscure the examples described herein. Also, the description is not considered as limiting the scope of the examples described herein.

It will be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

Although the above principles have been described with reference to certain specific examples, various modifications thereof will be apparent to those skilled in the art as outlined in the appended claims.

1. A flexible bridge assembly for eyewear comprising:
a flexible bridge portion having a first recess at one end, and a second recess at another end;
a first rigid attachment member connected at a first end thereof to the first recess of the flexible bridge portion;
a second rigid attachment member connected at a first end thereof to the second recess of the flexible bridge portion; and
a deformable rigid bar extending between the first and second rigid attachment members and embedded within the flexible bridge portion.

2. The flexible bridge assembly of claim 1, wherein the flexible bridge portion and first and second attachment members are secured to each other via passages in each that are aligned when first and second attachment members are inserted into the first and second recesses of the flexible bridge portion and the deformable rigid bar is embedded within the flexible bridge portion.

3. The assembly of claim 2, wherein fasteners are inserted through the aligned passages to join the flexible bridge portion to the first and second attachment members.

4. The flexible bridge assembly of claim 1, wherein the flexible bridge portion is overmolded over the deformable rigid bar.

5. An eyewear assembly comprising the flexible bridge assembly of claim 1, coupled to a first lens retainer adapted to hold a first lens, and to a second lens retainer adapted to hold a second lens.

6. The eyewear assembly of claim 5, wherein the first lens retainer includes a third recess, and the second lens retainer includes a fourth recess to receive second ends of the first and second rigid attachment members, respectively.

7. The eyewear assembly of claim 6, wherein the first and second rigid attachment members and the first and second lens retainers have passages that are aligned when the first and second attachment members are inserted into the third and fourth recesses.

8. The eyewear assembly of claim 7, wherein fasteners are inserted through the aligned passages and through the lens retainers to join the flexible bridge assembly to the first and second lens retainers.

9. The eyewear assembly of claim 8, wherein the fasteners comprise a resin inserted into the aligned passages through the lens retainers and subsequently cured.

10. The eyewear assembly of claim 9, wherein the fasteners are processed to be flush with the lens retainers and the flexible bridge portion.

11. The eyewear assembly of claim 5, wherein the first rigid attachment member comprises at least one prong and the second attachment member comprises at least one prong; wherein the at least one prong of the first rigid attachment member is configured to be received into and be secured within the third recess of the first lens retainer; and the at least one prong of the second rigid attachment member is configured to be received into and be secured within the fourth recess of the second lens retainer.

12. A flexible bridge assembly for eyewear comprising:
a flexible bridge portion;
a first rigid connecting end embedded in the flexible bridge portion at one end;
a second rigid connecting end embedded in the flexible bridge portion at the other end; and
a deformable rigid bar extending between the first and second rigid connecting ends and embedded within the flexible bridge portion.

13. The flexible bridge assembly of claim 12, wherein the flexible bridge is overmolded over the first and second connecting ends and the deformable rigid bar.

14. The flexible assembly of claim 13, wherein the first and second connecting ends each comprise at least one passage for receiving material applied in overmolding the flexible bridge.

15. An eyewear assembly comprising the flexible bridge assembly of claim 12 coupled to a first lens retainer adapted to hold a first lens, and to a second lens retainer adapted to hold a second lens.

16. The eyewear assembly of claim 15, wherein the first lens retainer is provided with a first recess and the second lens retainer is provided with a second recess for receiving the first and second connecting ends.

17. The eyewear assembly of claim 16, wherein the first and second connecting ends and the first and second lens retainers comprise passages that become aligned when the first and second connecting ends are inserted into the first and second recesses of the lens retainers and the deformable rigid bar is embedded within the flexible bridge portion.

18. A flexible bridge assembly for eyewear, the eyewear comprising a first lens retainer and a second lens retainer, the flexible bridge assembly comprising:
a first rigid attachment member having at least one prong and at least one slot;
a second rigid attachment member having at least one prong and at least one slot; and
a flexible bridge portion comprising a deformable rigid bar extending between the first and second rigid attachment members,
wherein the prongs of the first rigid attachment members provide an attachment portion for at least one recess provided in the first lens retainer; and the prongs of the second rigid attachment members provide an attachment portion for at least one recess of the second lens retainer.

19. The flexible eyewear assembly of claim 18, wherein the flexible bridge portion and first and second rigid attachment members are secured to each other via an overmolding process when the slots of the first and second attachment members receive material during the overmolding process to create the flexible bridge portion.

20. The eyewear assembly of claim 19, wherein the first and second rigid attachment members and the first and second lens retainers comprise passages that become aligned when the first and second attachment members are inserted into the first and second recesses of the lens retainers and the deformable rigid bar is embedded within the flexible bridge portion.
